(19) United States
(12) Patent Application Publication
(10) Pub. No.: US 2024/0087425 A1
(43) Pub. Date: Mar. 14, 2024

(54) SYSTEM AND METHOD FOR MANAGING SPORTS BETTING AND PROVIDING REAL-TIME UPDATES

(71) Applicant: Derrick Darby, BRONX, NY (US)

(72) Inventor: Derrick Darby, BRONX, NY (US)

(21) Appl. No.: 17/940,168

(22) Filed: Sep. 8, 2022

(51) Int. Cl. G07F 17/32; G06Q 50/34

(52) U.S. Cl. CPC G07F 17/3288; G06Q 50/34; G07F 17/323

(57) ABSTRACT

Systems and methods are provided herewith for managing sports betting with real-time updates over a server comprising a memory and at least one processor that executes instructions stored on the memory. The instructions comprise storing in the database one or more bets placed by a first user on one or more sportsbook applications, each bet having an initial true odds of winning and an initial true wager value based upon the initial true odds of winning; storing a predetermined value range, selected by the first user, for each bet at which to automatically cash out, retrieving real-time updates pertaining to bets, calculating revised true odds of winning for each bet, and calculating revised true wager value based upon the revised true odds of winning; and automatically cashing out any of the bets whose revised true wager value falls within its predetermined value range.

### FIELD OF THE INVENTION

The present invention relates to a system and method for managing sports betting and providing real-time updates.

### BACKGROUND OF THE INVENTION

Online sports betting has been experiencing a massive growth in popularity and accessibility since the 2018 U.S. Supreme Court ruling that opened the doors for sports betting outside of Nevada. Since then, 22 states have legalized at least some form of online sports betting, with the possibility of more states on the way. To meet this growing demand, there are now dozens of online sportsbook applications that users, depending on in which state they live, can use to manage their sports betting.

Real time sports betting, also known as in-play betting, has gained in significant popularity with the introduction of computer algorithms for generated betting odds. Sportsbook applications run these algorithms on high-speed servers to provide the statistical analysis in real time and turn it into betting odds within seconds.

### SUMMARY OF THE INVENTION

In one embodiment, a server to manage sports betting and provide real-time updates is disclosed, the server comprising at least one processor configured to communicate with at least one computing device over a communication network, and a memory, in which the memory stores instructions which, when executed by the at least one processor, direct the at least one processor to store on a database in the memory one or more bets placed by a first user on one or more sportsbook applications of the server, each one of the one or more bets has an initial true odds of winning and a corresponding wager having an initial true wager value based upon the initial true odds of winning; store a predetermined value range for each one of the one or more bets at which to automatically cash out, the predetermined value range is selected by the first user; retrieve real-time data updates pertaining to the one or more bets, calculate a revised true odds of winning for each one of the one or more bets, and calculate a revised true wager value based upon the revised true odds of winning; and automatically cash out any one of the one or more bets whose revised true wager value falls within the predetermined value range.

In one embodiment, the server further comprises instructions to access at least one sportsbook application on at least one external server, retrieve a first data set comprising at least one bet placed by the first user on the at least one sportsbook, and store the at least first data set on the database in the memory; the at least one bet having an initial odds of winning and a corresponding wager having an initial wager value based upon the initial odds of winning; calculate for the at least one bet an initial true odds of winning and an initial true wager value based upon the initial true odds of winning; store a predetermined value range for the at least one bet at which to automatically cash out, the predetermined value ranger is selected by the first user; retrieve real-time data updates pertaining to the at least one bet, calculate a revised true odds of winning for the at least one, and calculate a revised true wager value based upon the revised true odds of winning; and automatically cash out any one of the one said at least one bet whose revised wager value falls within the predetermined value range.

In one embodiment, the server further comprises instructions to determine if any one of the one or more bets and the at least one bet includes at least a first bet corresponding to a live sporting event and at least a second bet which conflicts with the at least first bet, the at least second bet corresponding to a live sporting event or a future sporting event; compare an initial true odds of winning and true wager value of the at least first bet and an initial true odds of winning and true wager value of the at least second bet, and calculate an expected value for each one of the at least first bet and the at least second bet; retrieve real-time data updates pertaining to the at least first bet and the at least second bet, calculate a revised true odds of winning and true wager value for each one of the at least first bet and the at least second bet, and calculate a revised expected value for each one of the at least first bet and the at least second bet; and determine which of the at least first bet and the at least second bet is more valuable to the first user and notify the first user.

In one embodiment, the server further comprises instructions to access an account of the first user on the at least one sportsbook application on the at least one external server, search available bets and place the at least one bet.

In one embodiment, a non-transitory computer-readable medium for manage sports betting and provide real-time updates is disclosed, the non-transitory computer-readable medium storing thereon instructions that, when executed by at least one processor of a server configured to communicate with at least one computing device over a communication network, direct the at least one processor to store on a database in the memory one or more bets placed by a first user on one or more sportsbook applications of the server, each one of the one or more bets has an initial true odds of winning and a corresponding wager having an initial true wager value based upon the initial true odds of winning; store a predetermined value range for each one of the one or more bets at which to automatically cash out, the predetermined value range is selected by said first user; retrieve real-time data updates pertaining to the one or more bets, calculate a revised true odds of winning for each one of said one or more bets, and calculate a revised true wager value based upon the revised true odds of winning; and automatically cash out any one of the one or more bets whose revised true wager value falls within the predetermined value range.

In one embodiment, the non-transitory computer-readable medium further comprises instructions to access at least one sportsbook application on at least one external server, retrieve a first data set comprising at least one bet placed by the first user on the at least one sportsbook, and store the at least first data set on the database in the memory; the at least one bet having an initial odds of winning and a corresponding wager having an initial wager value based upon the initial odds of winning; calculate for the at least one bet an initial true odds of winning and an initial true wager value based upon the initial true odds of winning; store a predetermined value range for the at least one bet at which to automatically cash out, the predetermined value ranger is selected by the first user; retrieve real-time data updates pertaining to the at least one bet, calculate a revised true odds of winning for the at least one, and calculate a revised true wager value based upon the revised true odds of winning; and automatically cash out any one of the at least one bet whose revised wager value falls within said predetermined value range.

In one embodiment, the non-transitory computer-readable medium further comprises instructions to determine if any one of the one or more bets and the at least one bet includes at least a first bet corresponding to a live sporting event and at least a second bet which conflicts with the at least first bet, the at least second bet corresponding to a live sporting event or a future sporting event; compare an initial true odds of winning and true wager value of the at least first bet and an initial true odds of winning and true wager value of the at least second bet, and calculate an expected value for each one of the at least first bet and said at least second bet; retrieve real-time data updates pertaining to the at least first bet and the at least second bet, calculate a revised true odds of winning and true wager value for each one of the at least first bet and the at least second bet, and calculate a revised expected value for each one of the at least first bet and the at least second bet; and determine which of the at least first bet and the at least second bet is more valuable to the first user and notify the first user.

In one embodiment, the non-transitory computer-readable medium further comprises instructions to access an account of the first user on the at least one sportsbook application on the at least one external server, search available bets and place the at least one bet.

In one embodiment, a method is disclosed for managing sports betting and providing real-time updates, the method comprising controlling, by at least one processor of a server configured to communicate with at least one computing device over a communication network; storing on a database in the memory one or more bets placed by a first user on one or more sportsbook applications of the server, each one of the one or more bets having an initial true odds of winning and a corresponding wager having an initial true wager value based upon the initial true odds of winning; storing a predetermined value range for each one of the one or more bets at which to automatically cash out, the predetermined value range is selected by the first user; retrieving real-time data updates pertaining to the one or more bets, calculating a revised true odds of winning for each one of the one or more bets, and calculating a revised true wager value based upon the revised true odds of winning; and automatically cashing out any one of the one or more bets whose revised true wager value falls within the predetermined value range.

In one embodiment, the method further comprises controlling, by the at least one processor; accessing at least one sportsbook application on at least one external server, retrieving a first data set comprising at least one bet placed by the first user on the at least one sportsbook, and storing the at least first data set on the database in the memory; the at least one bet having an initial odds of winning and a corresponding wager having an initial wager value based upon the initial odds of winning; calculating for the at least one bet an initial true odds of winning and an initial true wager value based upon the initial true odds of winning; storing a predetermined value range for the at least one bet at which to automatically cash out, the predetermined value ranger is selected by the first user; retrieving real-time data updates pertaining to the at least one bet, calculating a revised true odds of winning for the at least one, and calculating a revised true wager value based upon the revised true odds of winning; and automatically cashing out any one of the at least one bet whose revised wager value falls within the predetermined value range.

In one embodiment, the method further comprises controlling, by the at least one processor; determining if any one of the one or more bets and the at least one bet includes at least a first bet corresponding to a live sporting event and at least a second bet which conflicts with said at least first bet, the at least second bet corresponding to a live sporting event or a future sporting event; comparing an initial true odds of winning and true wager value of the at least first bet and an initial true odds of winning and true wager value of the at least second bet, and calculating an expected value for each one of the at least first bet and the at least second bet; retrieving real-time data updates pertaining to said at least first bet and said at least second bet, calculating a revised true odds of winning and true wager value for each one of said at least first bet and said at least second bet, and calculating a revised expected value for each one of said at least first bet and said at least second bet; and; and determining which of the at least first bet and the at least second bet is more valuable to the first user and notifying the first user.

In one embodiment, the method further comprises controlling, by the at least one processor; accessing an account of the first user on the at least one sportsbook application on the at least one external server, searching available bets and placing the at least one bet.

### BRIEF DESCRIPTION OF THE DRAWINGS

FIG. 1 is a schematic illustration of an example system architecture for a system and method for managing sports wagers and providing real-time true value updates.

Like reference numbers and designations in the various drawings indicate like elements.

### DETAILED DESCRIPTION OF THE PREFERRED EMBODIMENT

Reference will be made in detail to the embodiments of the disclosure, examples of which are illustrated in the accompanying drawings.

### INCORPORATION BY REFERENCE

The following U.S. patents and published U.S. patent applications are incorporated by reference in their entirety:
Patent Document 1: U.S. Patent App. Pub. No. 20210049490 published on Feb. 18, 2021, titled “System, Method, and Platform for Generating a Real-Time Bet Win Probability”;
Patent Document 2: U.S. Patent App. Pub. No. 20210049726 published on Feb. 18, 2021, titled “System, Method, and Platform for Generating Real-Time Portfolio Expected Value”;
Patent Document 3: U.S. patent Ser. No. 11/127,250 issued on Sep. 21, 2021, titled “AI Sports Betting Algorithms Engine”;
Patent Document 4: U.S. patent Ser. No. 11/200,776 issued on Dec. 14, 2021, titled “Wagering on event outcomes during the event”;
Patent Document 5: U.S. patent Ser. No. 11/238,703 issued on Feb. 1, 2022 titled “Wager market creation and management”; and
Patent Document 6: U.S. patent Ser. No. 11/183,010 issued on Nov. 23, 2021, titled “Secure Bet Synchronization and Betting Analytics”;

Any patent, patent application or other document referred to herein is incorporated by reference into this patent application as part of the present disclosure, but only for purposes of written description and enablement in accordance with 35 U.S.C. § 112(a), and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### Problems the Invention Intends to Solve

Computer algorithms for generated betting odds are disclosed in the following Patent Documents 1-4 (see also Patent Document 5, identified below), which are incorporated herein by reference in their entirety.

Patent Document 1: U.S. Patent App. Pub. No. 20210049490. Patent Document 1 discloses a system, method, and electronic online platform that provide a probability of a wager winning in real-time updates as live in-game data is provided to a model calculating a current probability of winning based on historical betting data. In particular, Patent Document 1 discloses computer program modules that execute the steps for receiving wagers, accessing pre-game historical betting data, accessing live in-game data, feeding data related to stored bets and current in-game data to an algorithm to generate a probability of winning for individual bets, and calculating an expected current probability of bets winning.

Patent Document 2: U.S. Patent App. Pub. No. 20210049726. Patent Document 2 discloses using a win probability algorithm that converts live in-game data and stored betting data about a game into the probability of those bets winning.

Patent Document 2 further discloses that its probability model may be developed using the techniques described in Patent Document 1 (disclosed above).

Patent Document 3: U.S. patent Ser. No. 11/127,250. Patent Document 3 discloses a system and method for wagering on outcomes of a live sporting event using an AI (artificial intelligence) sports betting algorithm engine comprising multiple databases and modules, including, but not limited to: a betting algorithms module, a cross module, an AI comparison module, a machine learning module, and an odds adjustment module.

Patent Document 4 (i.e., U.S. patent Ser. No. 11/200,776) discloses methods and systems for generating real-time odds for a live sporting event, including updating the odds in real-time, using an odds database and algorithm stored on the system. Patent Document 4 discloses using a plurality of modules, including, but not limited to: a probability module, an odds module, a data provider module (to obtain information about an event), a state identification module, a parameter creation module, a parameter tracking module, a betting market module, and a create-a-metric module.

Due to the availability of numerous online sportsbook applications, as mentioned above, sports bettors may desire to track their sports betting from a single app rather than have to constantly switch between various apps to stay informed of their bets. This is especially important to a sports bettor who has multiple in-play bets (described above) whose odds and value may change in a moment. A system and method for tracking bets placed on multiple sportsbooks from a single app is disclosed in at least the following Patent Document 6, which is incorporated herein by reference in its entirety.

Patent Document 6: U.S. patent Ser. No. 11/183,010. Patent Document 6 discloses a system and method for “bet synchronization,” which refers to a user having an account on a first server, wherein the first server is able to retrieve information about bets placed by the user at multiple sportsbooks of external entities and perform data analytics with the retrieved information (e.g., to analyze the user's betting history and display the user's past win/loss trends, to make future recommendations, etc.).

First deficiency in the art. Sports bettors must rely on the odds and wager values provided by the sportsbooks, as it is virtually impossible to calculate the odds without using a computer-based system and method as described above. For in-play betting, the odds and wager value can change at a moment's notice (as mentioned above) and sports bettors may wish to cash out if they believe they stand to lose more money by “letting the bet ride.” However, the cash out value provided by the sportsbooks are often calculated as not representing the actual or “true” value of the bet at the time. This is due to the profit motive of sportsbooks—i.e., that the sportsbooks will offer a much lower cash out than the bet is actually worth at the moment. Thus, sports bettors may be unsure whether they should accept the sportsbook cash out offer.

Second deficiency in the art. In order for a sports bettor to accept a cash out offer, they must first be aware of the offer. This may be partially solved by the above system and method for “bet synchronization” disclosed in Patent Document 6, whereby all of the user's bets are available for viewing from a single app. However, a sports bettor may miss a cash out offer if they are not viewing the app at the moment and, even if they are, they must access the correct sportsbook application and manually cash out before the offer is removed.

Third deficiency in the art. Sports bettors must manually search, within each sportsbook application, for individual bets. This is not an efficient use of their time as they may miss out on other betting opportunities in other sportsbook applications.

Fourth deficiency in the art. Sometimes a sports bettor may have two or more bets that are in “conflict” as defined below. The Journal of Gambling Studies published an article titled “Why Do Individuals Engage in In-Play Sports Betting? A Qualitative Interview Study” (Aug. 13, 2021) (retrievable at https://doi.org/10.1007/s10899-020-09968-9) in which they reported that “Many participants . . . took part in in-play sports betting because it increased their engagement with the game. This is because it made the game more exciting to watch because there was an opportunity for monetary gain.” Where a sports bettor has a wager on Team A to win that evening, but that if Team A wins, another bet on Team B will go down in value so as to cause a greater loss to the sports bettor than if Team A loses that evening. Having this knowledge, the sports bettor may wish to cheer against Team A that evening since their loss likely means a greater financial gain with Team B later.

### Definitions

The following is a list of definitions for terms and words used herein:

As used herein, the term “bet” refers to the action of placing a wager—i.e., a bet describes an agreement between two parties to give or receive a specific amount of money (i.e., the wager) based on the outcome of an event. For example, two friends might bet on the winner of the Super Bowl a wager of $10; the friend who bet on the winner would receive $10 (the “wager”) from the friend who bet on the opposite outcome.

As used herein, the term “cash out,” otherwise known as a “buy out,” is a feature that allows sports bettors the ability to settle a bet—and accept a payout less than the full potential win—before the competition ends. Cash Out offers are determined through a combination of real-time odds (i.e., odds updated in real-time when one or more factors change the initial odds) and removal of risk based on the initial wager amount.

As used herein, the term “conflicting bet” refers to where any two or more of a user's bets are in conflict—i.e., the expected value (EV) of a first bet may be influenced by the outcome of a second bet, as described below in more detail.

As used herein, the term “expected value (EV)” refers to the amount a player can expect to win or lose if they were to place a bet on the same odds many times over, calculated through a simple equation multiplying your probability of winning with the amount you could win per bet, and subtracting the probability of losing multiplied by the amount lost per bet. Thus, Expected Value of a bet is how much a bettor can expect to win (on average) per bet, and as such is a very valuable calculation for a bettor to make when comparing bookmakers odds.

As used herein, the term “initial true odds of winning” refers to the odds as determined by the odds/wager true value module of the first server 110, described below. This could refer to the initial setting of the true odds when the bet was first created or at a later point in time by a user who entered into the bet subsequent to the creation of the bet. Thus, it is an “initial” true odds from the perspective of the user. It should be noted that the “initial true odds of winning” is assigned to both those bets that were placed with a sportsbook of server 110 as well as with those bets that are placed with a sportsbook of an external server, such as server 210 and later retrieved by server 110 and stored on database 112, as described below in more detail.

As used herein, the term “initial odds of winning” refers to the odds as determined by the odds/wager value module of the second server 210, described below. This could refer to the initial setting of the odds when the bet was first created or at a later point in time by a user who entered into the bet subsequent to the creation of the bet. Thus, it is an “initial” odds from the perspective of the user.

As used herein, the term “initial true wager value” refers to the wager value as determined by the odds/wager true value module. This could refer to the initial setting of the wager value when the bet was first created or at a later point in time by a user who entered into the bet subsequent to the creation of the bet. Thus, it is an “initial” value from the perspective of the user.

As used herein, the term “initial wager value” refers to refers to the wager value assigned based on the original odds or the odds at the time a bet is entered into by a user (which may reflect a revised wager value to another user who had entered into the same bet at an earlier time). Thus, it is an “initial” value from the perspective of the user.

As used herein, the term “lines” is another term for the odds.

As used herein, the term “real time,” when used in connection with an event or occurrence, means that the event or occurrence occurs at the same time as or at substantially the same time as the occurrence of an associated reference event. For instance, receiving and displaying video footage of an event (such as a kickoff of a football game) in “real time” means that the footage is received and displayed at substantially the same time as the event is taking place, as in a traditional “live broadcast” of a sporting event. It should be understood that there are often very small delays between an occurrence and a “real time” display of the occurrence. For instance, it takes a very small amount of time to process a video signal, transmit it to a broadcast tower, transmit it to a receiver, decode the transmission, and display it at a display device. In spite of the slight delay, such a display is still in “real time.” It may also take a small amount of time for a reporter or announcer at the game to provide a running audio or text commentary.

As used herein, the term “real time data updates” refers to updates based on in-game events.

As used herein, the term “real time odds” refers to live lines that update immediately as sportsbooks adjust their lines.

As used herein, the term “revised odds of winning” refers to the odds of winning after it has been adjusted by the odds/wager value module of server 210 in view of real-time updates. (Compare with the definition of “initial odds of winning” provided above.)

As used herein, the term “revised true odds of winning” refers to the true odds of winning after it has been adjusted by the odds/wager true value module of server 110 in view of real-time updates. (Compare with the definition of “initial true odds of winning” provided above.)

As used herein, the term “revised true wager value” refers to the true wager value after it has been adjusted by the odds/wager true value module of server 110 in view of real-time updates. (Compare with the definition of “initial true wager value” provided above.)

As used herein, the term “revised wager value” refers to the wager value after it has been adjusted by the odds/wager value module of server 210 in view of real-time updates. (Compare with the definition of “initial wager value” provided above.)

As used herein, the term “search module” refers to a module that is capable of accessing one or more sportsbook applications of the first server to search for available bets based upon the search criteria specified by a user accessing the server. The search module may be configured to access one or more sportsbook applications on a second (i.e., external) server, as described below in more detail.

As used herein, the term “sportsbook” refers to a company or individual who accepts bets from individual sports bettors. Sportsbooks generally accept bets on either side of a sporting event. A sportsbook application is a sportsbook that operates online, such as via an application or a website.

As used herein, the term “true value” of odds of winning a bet, also known as “fair odds, refers to the chances of winning if the sportsbook didn't add the “vig,” which is the sportsbook's cut for taking the bet. For example, a standard points spread bet will have −110 odds. That extra −10 is the vig. (A sportsbook can assign a different value for the vig and thus provide different odds.) So, when you use the vig free calculator, the odds will be presented as if that vig wasn't added. In the −110 example, the no vig calculator would show +100 odds and a 50% true probability.

As used herein, the term “wager” refers to the amount of money risked on a specific outcome of a sporting event to receive a payout if that outcome occurs. The bettor loses that money wagered if the outcome does not come to fruition.

### Architecture of First Server

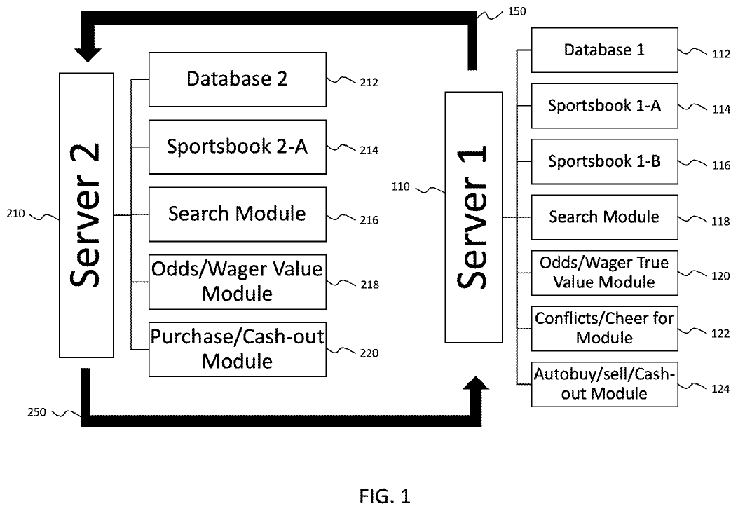

FIG. 1 is a system and method of calculating and displaying the true value of one or more bets placed by a first user on one or more sportsbooks. The system 100 comprises a first server 110 (i.e., “Server 1” in FIG. 1), which may be referred to as an “internal” server. The server 110 comprises a database 112 (e.g., “Database 1” in FIG. 1), one or more sportsbook applications 114 and 116 (e.g., “Sportsbook 1-A” and “Sportsbook 1-B” in FIG. 1, respectively), a search module 118, an odds/wager true value module 120, a conflicts/cheer for module 122, and an auto-buy/auto-sell/cash-out module 124.

### Architecture of Second Server

The system 100 further comprises at least a second server 210 (i.e., “Server 2” in FIG. 1), which may be referred to as an “external” server in relation to the “internal” first server 110. The second server 210 comprises a database 212 (e.g., “Database 2” in FIG. 1), at least one sportsbook application 214 (e.g., “Sportsbook 2-A” in FIG. 1), a search module 216, an odds/wager value module 218, and a purchase/cash-out module 220. System 100 may include multiple “external” servers, each having at least one sportsbook application, each of which may be accessed by server 110, as discussed below in further detail.

### True Value Module—First Server

In one embodiment, server 110 stores on database 112 one or more bets (126) placed by a first user on the one or more sportsbook applications 114 and 116 of server 110. (Note that reference numerals appearing in parentheses—e.g., “(126)”—are not assigned to a drawing.) The first user may optionally use the search module 118 to search available bets upon which to place a wager. Each one of the one or more bets (126) is assigned by the odds/wager true value module 120 an initial true odds of winning and a corresponding wager having an initial true wager value based upon the initial true odds of winning. Server 110 notifies the first user of the foregoing initial true odds of winning and the corresponding initial true wager value. The first user may buy, claim or cash-out winnings from the one or more bets (126) via the auto-buy/sell/cash-out module 124.

In one embodiment, Server 110 is configured to retrieve real-time data updates pertaining to the one or more bets (126) placed by the first user, the real-time data updates being stored on database 112. Based upon the foregoing real-time updated data, odds/wager true value module 120 calculates a revised true odds of winning for each one of the one or more bets (126), and calculate a revised true wager value based upon the revised true odds of winning. Server 110 notifies the first user of the foregoing revised true odds of winning and the corresponding revised true wager value. The first user may buy, claim or cash-out winnings from the one or more bets (126) via the auto-buy/sell/cash-out module 124.

### Automatic Cash-Out Module—First Server

In one embodiment, database 112 is configured to store a predetermined value range selected by the first user for each one of the one or more bets (126) at which to automatically cash out any one of the bets, via the auto-buy/sell/cash-out module 124, whose revised true wager value falls within the predetermined value range.

### Purchasing Bets Directly on Second Server

In one embodiment, server 210 stores on database 212 at least one bet (222) placed by the first user on the at least one sportsbook application 214 of server 210. The first user uses the search module 216 to search available bets (i.e., the at least one bet [222]) upon which to place a wager. The at least one bet (222) is assigned by the odds/wager value module 218 an initial odds of winning and a corresponding wager having an initial wager value based upon the initial odds of winning. The first user may buy, claim or cash-out winnings from the at least one bet (222) via the purchase/cash-out module 220.

### Remotely Purchasing Bets on Second Server Via First Server

In one embodiment, the first user utilizes search module 118 of server 110 to search the at least one sportsbook application 214 of server 210 for available bets upon which to place a wager. In this embodiment, search module 118 instructs server 110 to access search module 216 of server 210. The first user places at least one bet (222) on the at least one sportsbook application 214, and the at least one bet (222) is stored on both database 212 of server 210 (as well as on database 112 of server 110, as described below).

### True Value Module—Second Server

In one embodiment, server 110 is configured to access database 212 of server 210 (the process of requesting access and connecting server 110 to server 210 is referred to herein as “Step A” or by reference numeral 150 shown in FIG. 1), retrieve a first data set (the process of receiving the first data set is referred to herein as “Step B” or by reference numeral 250 shown in FIG. 1) comprising the at least one bet (222) placed by said first user on the at least one sportsbook 214 of server 210, and store said at least first data set on database 112 of server 110. The at least one bet (222) is assigned by the odds/wager value module 218 of server 210 an initial odds of winning and a corresponding wager having an initial wager value based upon the initial odds of winning. The odds/wager true value module 120 of server 110 is configured to calculate, for the at least one bet (222) stored on database 112, an initial true odds of winning and an initial true wager value based upon said initial true odds of winning.

### Automatic Cash-Out Module—Second Server

In one embodiment, database 112 is configured to store a predetermined value range selected by the first user for each one of the at least one bet (222) stored on database 112 at which to automatically cash out one or more bets (224), from the at least one bet (222), whose revised true wager value falls within the predetermined value range. This automatic cash-out is carried out when the auto-buy/sell/cash-out module 124 of server 110 instructs the purchase/cash out module 220 of server 210 to cash-out the one or more bets (224). In another embodiment, the auto-buy/sell/cash-out module 124 instructs server 110 to notify the first user to cash out the one or more bets (224). The first user then manually enters an instruction in the purchase/cash-out module 220 of server 210 to cash out the one or more bets (224).

### Conflicts/Cheer for Module

In one embodiment, where the first user has multiple bets (128) stored in database 112, the conflicts/cheer for module 124 determines whether any two or more of the first user's bets are in conflict—i.e., the expected value (EV) of a first bet (130) may be influenced by the outcome of a second bet (132). The definition of the terms “conflict” and “expected value (EV)” as used herein are provided above in the definitions section of the Detailed Description. Conflicts/cheer for module 124 then calculates which of the two or more conflicting bets has a greater expected value for the first user. Server 112 then displays the results to the first user. The multiple bets (128) may comprise only the one or more bets (126) placed by the first user on the one or more sportsbook applications 114 and 116 of server 110, or only the at least one bet (222) placed by the first user on the at least one sportsbook application 214 of server 210 (i.e., where the at least one bet (222) comprises more than one bet), or a combination thereof. The first bet (130) corresponds to a live sporting event and the second bet (132) corresponds to a live sporting event or a future sporting event. There may be multiple bets that “conflict” with the first bet (130). Accordingly, the second bet (132) may comprise a plurality of bets corresponding to two or more live sporting events, two or more future sporting events, or a combination of at least one of each type.

In further detail, the conflicts/cheer for module 122 compares an initial true odds of winning and true wager value of the first bet (130) and an initial true odds of winning and true wager value of the second bet (132), calculates an expected value of the first bet (130) and an expected value of the second bet (132), retrieves real-time data updates pertaining to the first bet (130) and the second bet (132), calculates a revised true odds of winning and true wager value for each one of the first bet (130) and the second bet (132), and determines which of the first bet (130) and the second bet (132) is more valuable to the first user (i.e., which has the greater expected value (EV) to the first user), and thereafter notify the first user via server 110. As described above, second bet (132) may comprise one or more bets that conflicts with the first bet (130).

As disclosed above, the system 100 of the present invention comprises a first server 110 (i.e., “Server 1” in FIG. 1) and at least a second server 210 (i.e., “Server 2” in FIG. 1), which may be referred to as an “external” server in relation to the “internal” first server 110. The second or external server 210 comprises a database 212 (e.g., “Database 2” in FIG. 1) and at least one sportsbook application 214 (e.g., “Sportsbook 2-A” in FIG. 1). A person having ordinary skill in the art (hereinafter, “PHOSITA”) would understand that the system 100 may further comprise additional “external” servers. A PHOSITA would also understand that each one of the external servers may comprise one or a plurality of databases and one or a plurality of sportsbook applications, each of which may be accessed by server 110, as described above in further detail. Accordingly, server 110 is capable of:
(A) accessing a plurality of external servers (as described above in greater detail);
(B) accessing a plurality of databases on the plurality of external servers (as described above in greater detail);
(C) accessing and searching a plurality of sportsbooks on each the plurality of servers and placing bets on each of the plurality of sportsbooks of the plurality of external servers (as described above in greater detail);
(D) retrieving a plurality of datasets from the plurality of databases on the plurality of external servers, each one of the plurality of datasets comprising one or more bets (and other information) placed by a user (as described above in greater detail);
(E) receiving and storing, on database 112 of server 110, the plurality of datasets (also referred to herein as the “imported datasets”), and calculating, via the odds/wager true value module, the true value for each one of the bets from the plurality of datasets (as described above in greater detail);
(F) monitoring, among the plurality of bets placed on the one or more sportsbooks 114 and 116 of server 110, each one of the bets having an associated predetermined value range selected by the respective user at which to automatically cash-out, via the auto-buy/sell/cash-out module 124, those bets whose revised true wager value falls within the predetermined value range (as described above in greater detail);
(G) monitoring, among the plurality of bets placed on the plurality of sportsbooks of the external servers, each one of the bets having an associated predetermined value range selected by the respective user at which to automatically cash-out those bets whose revised true wager value falls within the predetermined value range, whereby the automatic cash-out is carried out when the auto-buy/sell/cash-out module 124 of server 110 instructs the purchase/cash out module 220 of server 210 to cash-out the aforementioned bet(s) (as described above in greater detail); and
(H) reviewing, separately for each one of the plurality of users who has a plurality of bets stored on database 112 of server 110, whether any two or more of the user's bets are in conflict, including retrieving real-time data updates pertaining to each of the conflicting bets, calculating a revised true odds of winning and true wager value for each one of the conflicting bets, and determining which of the conflicting bets is more valuable to the first user (as described above in greater detail).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a non-transitory computer storage medium for execution by, or to control the operation of, data processing apparatus. Alternatively or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer readable storage device, a computer readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Thus, particular embodiments of the subject matter have been described.

The following is a list of reference numerals and associated parts as used in this specification and drawings:

| Reference Numeral | Part |
|---|---|
| System | 100 |
| First server (Server 1) | 110 |
| Database (Database 1) | 112 |
| One or more sportsbook application | 114 |
| One or more sportsbook application | 116 |
| Search module | 118 |
| True value module | 120 |
| Conflicts module | 122 |
| Cash-out module | 124 |
| One or more bets placed by a first user | 126 |
| on the one or more sportsbook | |
| applications 114 and 116 of server 110 | |
| Multiple bets stored in database 112 | 128 |
| First bet | 130 |
| Second bet | 132 |
| Request for access and connecting | 150 |
| server 110 to server 210 (Step A) | |
| Second server (Server 2) | 210 |
| Database (Database 2) | 212 |
| At least one sportsbook application of | 214 |
| server 210 | |
| Search module | 216 |
| Odds/wager value module | 218 |
| Cash-out module | 220 |
| At least one bet | 222 |
| One or more bets | 224 |
| Receiving the first data set from | 250 |
| server 210 (Step B) | |

While the invention has been described in its preferred forms or embodiments with some degree of particularity, it is understood that this description has been given only by way of example and that numerous changes may be made without departing from the spirit and scope of the invention.

What is claimed:

1. A server comprising:
at least one processor configured to communicate with at least one computing device over a communication network; and
a memory, in which the memory stores instructions which, when executed by the at least one processor, direct the at least one processor to:
store on a database in said memory one or more bets placed by a first user on one or more sportsbook applications of said server, each one of said one or more bets has an initial true odds of winning and a corresponding wager having an initial true wager value based upon said initial true odds of winning;
store a predetermined value range for each one of said one or more bets at which to automatically cash out, said predetermined value range is selected by said first user;
retrieve real-time data updates pertaining to said one or more bets, calculate a revised true odds of winning for each one of said one or more bets, and calculate a revised true wager value based upon said revised true odds of winning; and
automatically cash out any one of said one or more bets whose revised true wager value falls within said predetermined value range.

2. The server of claim 1, in which the instructions, when executed by the at least one processor, direct the at least one processor to:
access at least one sportsbook application on at least one external server, retrieve a first data set comprising at least one bet placed by said first user on said at least one sportsbook, and store said at least first data set on said database in said memory; said at least one bet having an initial odds of winning and a corresponding wager having an initial wager value based upon said initial odds of winning;
calculate for said at least one bet an initial true odds of winning and an initial true wager value based upon said initial true odds of winning;
store a predetermined value range for said at least one bet at which to automatically cash out, said predetermined value ranger is selected by said first user;
retrieve real-time data updates pertaining to said at least one bet, calculate a revised true odds of winning for said at least one, and calculate a revised true wager value based upon said revised true odds of winning; and
automatically cash out any one of said one said at least one bet whose revised wager value falls within said predetermined value range.

3. The server of claim 2, in which the instructions, when executed by the at least one processor, direct the at least one processor to:
determine if any one of said one or more bets and said at least one bet includes at least a first bet corresponding to a live sporting event and at least a second bet which conflicts with said at least first bet, said at least second bet corresponding to a live sporting event or a future sporting event;
compare an initial true odds of winning and true wager value of said at least first bet and an initial true odds of winning and true wager value of said at least second bet, and calculate an expected value for each one of said at least first bet and said at least second bet;
retrieve real-time data updates pertaining to said at least first bet and said at least second bet, calculate a revised true odds of winning and true wager value for each one of said at least first bet and said at least second bet, and calculate a revised expected value for each one of said at least first bet and said at least second bet; and
determine which of said at least first bet and said at least second bet is more valuable to said first user and notify said first user.

4. The server of claim 2, in which the instructions, when executed by the at least one processor, direct the at least one processor to:
access an account of said first user on said at least one sportsbook application on said at least one external server, search available bets and place said at least one bet.

5. A non-transitory computer-readable medium to store thereon instructions that, when executed by at least one processor of a server configured to communicate with at least one computing device over a communication network, direct the at least one processor to:
store on a database in said memory one or more bets placed by a first user on one or more sportsbook applications of said server, each one of said one or more bets has an initial true odds of winning and a corresponding wager having an initial true wager value based upon said initial true odds of winning;
store a predetermined value range for each one of said one or more bets at which to automatically cash out, said predetermined value range is selected by said first user;
retrieve real-time data updates pertaining to said one or more bets, calculate a revised true odds of winning for each one of said one or more bets, and calculate a revised true wager value based upon said revised true odds of winning; and
automatically cash out any one of said one or more bets whose revised true wager value falls within said predetermined value range.

6. The non-transitory computer-readable medium of claim 5, in which the instructions, when executed by the at least one processor, direct the at least one processor to:
access at least one sportsbook application on at least one external server, retrieve a first data set comprising at least one bet placed by said first user on said at least one sportsbook, and store said at least first data set on said database in said memory; said at least one bet having an initial odds of winning and a corresponding wager having an initial wager value based upon said initial odds of winning;
calculate for said at least one bet an initial true odds of winning and an initial true wager value based upon said initial true odds of winning;
store a predetermined value range for said at least one bet at which to automatically cash out, said predetermined value ranger is selected by said first user;
retrieve real-time data updates pertaining to said at least one bet, calculate a revised true odds of winning for said at least one, and calculate a revised true wager value based upon said revised true odds of winning; and
automatically cash out any one of said at least one bet whose revised wager value falls within said predetermined value range.

7. The non-transitory computer-readable medium of claim 6, in which the instructions, when executed by the at least one processor, direct the at least one processor to:
determine if any one of said one or more bets and said at least one bet includes at least a first bet corresponding to a live sporting event and at least a second bet which conflicts with said at least first bet, said at least second bet corresponding to a live sporting event or a future sporting event;
compare an initial true odds of winning and true wager value of said at least first bet and an initial true odds of winning and true wager value of said at least second bet, and calculate an expected value for each one of said at least first bet and said at least second bet;
retrieve real-time data updates pertaining to said at least first bet and said at least second bet, calculate a revised true odds of winning and true wager value for each one of said at least first bet and said at least second bet, and calculate a revised expected value for each one of said at least first bet and said at least second bet; and
determine which of said at least first bet and said at least second bet is more valuable to said first user and notify said first user.

8. The non-transitory computer-readable medium of claim 6, in which the instructions, when executed by the at least one processor, direct the at least one processor to:
access an account of said first user on said at least one sportsbook application on said at least one external server, search available bets and place said at least one bet.

9. A method, comprising:
controlling, by at least one processor of a server configured to communicate with at least one computing device over a communication network:
storing on a database in said memory one or more bets placed by a first user on one or more sportsbook applications of said server, each one of said one or more bets having an initial true odds of winning and a corresponding wager having an initial true wager value based upon said initial true odds of winning;
storing a predetermined value range for each one of said one or more bets at which to automatically cash out, said predetermined value range is selected by said first user;
retrieving real-time data updates pertaining to said one or more bets, calculating a revised true odds of winning for each one of said one or more bets, and calculating a revised true wager value based upon said revised true odds of winning; and
automatically cashing out any one of said one or more bets whose revised true wager value falls within said predetermined value range.

10. The method of claim 9, further comprising:
controlling, by the at least one processor:
accessing at least one sportsbook application on at least one external server, retrieving a first data set comprising at least one bet placed by said first user on said at least one sportsbook, and storing said at least first data set on said database in said memory; said at least one bet having an initial odds of winning and a corresponding wager having an initial wager value based upon said initial odds of winning;
calculating for said at least one bet an initial true odds of winning and an initial true wager value based upon said initial true odds of winning;
storing a predetermined value range for said at least one bet at which to automatically cash out, said predetermined value ranger is selected by said first user;
retrieving real-time data updates pertaining to said at least one bet, calculating a revised true odds of winning for said at least one, and calculating a revised true wager value based upon said revised true odds of winning; and
automatically cashing out any one of said at least one bet whose revised wager value falls within said predetermined value range.

11. The method of claim 10, further comprising:
controlling, by the at least one processor:
determining if any one of said one or more bets and said at least one bet includes at least a first bet corresponding to a live sporting event and at least a second bet which conflicts with said at least first bet, said at least second bet corresponding to a live sporting event or a future sporting event;
comparing an initial true odds of winning and true wager value of said at least first bet and an initial true odds of winning and true wager value of said at least second bet, and calculating an expected value for each one of said at least first bet and said at least second bet;
retrieving real-time data updates pertaining to said at least first bet and said at least second bet, calculating a revised true odds of winning and true wager value for each one of said at least first bet and said at least second bet, and calculating a revised expected value for each one of said at least first bet and said at least second bet; and
determining which of said at least first bet and said at least second bet is more valuable to said first user and notifying said first user.

12. The method of claim 10, further comprising:
controlling, by the at least one processor:
accessing an account of said first user on said at least one sportsbook application on said at least one external server, searching available bets and placing said at least one bet.
